(19) United States
(12) Patent Application Publication
(10) Pub. No.: US 2025/0103988 A1
(43) Pub. Date: Mar. 27, 2025

(54) EXTERNAL BENCHMARKS FOR PROCESS MINING GRAPHS

(71) Applicant: SAP SE, Waldorf (DE)

(72) Inventors: Gregor Berg, Berlin (DE); Timotheus Kampik, Walldorf (DE); Stephan Baier, Walldorf (DE)

(21) Appl. No.: 18/473,505

(22) Filed: Sep. 25, 2023

(51) Int. Cl. G06Q 10/0633; G06F 16/538

(52) U.S. Cl. CPC G06Q 10/0633; G06F 16/538

(57) ABSTRACT

Provided is a system and method for evaluating the performance of a process using external process data, for example, from another similar process. In one example, the method may include generating a diagram of a process based on data from the process, where the diagram comprises a sequence of nodes that correspond to a sequence of events and edges between the sequence of nodes which indicate execution times between the events, displaying the diagram via a user interface of a software application, selecting a reference diagram of a reference process that includes a different sequence of nodes corresponding to a different sequence of events, identifying an improvement to the process based on the reference diagram, and modifying the diagram to include a different execution flow included in the reference diagram based on the identified improvement.

### BACKGROUND

Many organizations rely on software to run their business such as enterprise resource planning (ERP) software. ERP helps companies create and track orders, generate and clear invoices, receive payments, interact with a website, and the like. ERP software also offers opportunities to perform process mining on the business process. Process mining is a technique that provides insight about a business process to an organization. In many cases, process mining includes executing algorithms on log data from a runtime environment of the business process to identify trends, patterns, variants and other details of the process and how it unfolds. The result of the processing mining is a graph (i.e., a diagram) that represents events within the process using elements in the diagram. The diagram usually provides the viewer with an understanding of how their own process performs without much insight into how to make it better.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a process of benchmarking a target process in accordance with example embodiments.

FIG. 2 is a diagram illustrating a view of a state space of a process including milestones and blockers within the process in accordance with example embodiments.

FIG. 3A is a diagram illustrating a user interface with examples of milestones and blockers within a process, in accordance with example embodiments.

FIG. 3B is a diagram illustrating a data set resulting from generating the milestones and blockers shown in FIG. 3B, in accordance with example embodiments.

FIG. 4 is a diagram illustrating an example of an event log that can be generated from the data set shown in FIG. 3B, in accordance with example embodiments.

FIG. 5 is a diagram of a process that may be generated based on document data such as the event log shown in FIG. 4, in accordance with example embodiments.

FIGS. 6A-6D are diagrams illustrating a process of identifying a suggested improvement to a target process based on a reference diagram of a reference process in accordance with example embodiments.

FIG. 7 is a diagram illustrating a process of modifying the diagram of the process shown in FIG. 5 based on an alternative flow from a reference diagram in accordance with example embodiments.

FIG. 8 is a diagram illustrating a process of analyzing variants among a target process and a reference process in accordance with example embodiments.

FIG. 9 is a diagram illustrating a method of generating a process graph based on process insights in accordance with example embodiments.

FIG. 10 is a diagram illustrating a computing system for use in the examples herein in accordance with example embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

Process mining is an analysis method that helps organizations improve the way that they run their business. The result of a process being mined is a graph diagram that visualizes the process. Traditional process mining methods merely provide descriptive analysis of the process within the diagram. If action recommendations are provided at all, they are typically provided based on rules that are hardcoded into the process mining software. To conclude, the process diagram provides little insight into how an organization can make their process better.

Furthermore, a realistic timeline for performing a process mining project is a few months and it requires process mining vendors that are familiar with the software system being mined. The vendors typically build custom dashboards and business logic for mining the process which requires significant manual development work. The result is significant time and costs being consumed. Further, there may be different business logics implemented between different vendors which prevents for a standardization for purposes of benchmarking. Another drawback is that process mining may “mine” the entire state space of the software for that process which, after accounting for customer-specific adaptions of the process, ultimately leads to a custom overview of the entire process. The payoff for the mining project can usually only be realized at this detailed level, which makes it prohibitively expensive to cover many processes.

Furthermore, once a mining project is complete, the data can continue to be monitored, but the data extraction can no longer be modified in an easy manner. As a result, if a mining project requires new or different requirements, a completely new mining project will need to be implemented.

The example embodiments include a software system (also described herein as a host system) that provides a suite of software that can generate a process diagram, such as those traditionally generated from process mining, using document data instead of runtime process data. The system can build a custom process diagram (e.g., graph) with nodes representing events or activities within the process and edges between the nodes representing a flow/execution dependencies among the events. Furthermore, the edges can be annotated with additional attributes of the process such as the average amount of execution time that it takes between two events, etc. However simply generating a custom process diagram still does not provide an owner/developer of the process with an understanding of how other processes in a similar field are performing the process in a different and improved manner.

According to various embodiments, the host system may generate additional insight into a process by externally “benchmarking” the customer's process against best-in-class process versions based on a common reference model. The reference model may be a maximum version of the process (all possible steps) while a customer has a subset of the maximum version. The benchmarking can visually show what steps are different in the process versions executed in other companies that are “external” to the customer thereby allowing the customer's process to be externally benchmarked. In doing so, the customer can visually see and understand how other process versions in the same field/business area are performing the process and what steps they are doing differently. For example, if another entity is performing the same process but with less execution time, the host system may identify which steps are causing the slower executing time in the target process and make suggestion on how to improve these steps. The steps may be extracted from the reference diagram and used to define changes to perform to create a target process.

By benchmarking the target process using data from process versions of other customers (i.e., external benchmarking), the example embodiments can provide helpful insight to process owners, department heads or developers of the software with actions and other process steps that can improve the execution of their own process. No other methodology of this kind exists today.

In the example embodiments, the reference model can be thought of as a complete picture of the process type including all possible known (i.e., defined) steps used by the other processes and the directed edges between these displaying the flow of the process. The host system may generate multiple reference models for different types of processes. The processes may be business processes, sales processes, ordering processes, delivery process, etc. The host system may compare the process diagram of a target process to a reference diagram (of a reference process) and identify changes that can be made to the target process to improve the target process based on the reference diagram. In addition, the host system can visually show these changes within the process diagram of the target process thereby visually showing the owner/developer of the process the changes that can be made to improve the process based on the best-practices of the industry. That is, the host system can provide a process overview as well as recommendations on how to fix/improve the process based on how other entities and organizations are performing the same process in a more efficient manner.

The events or activities that are described herein may refer to milestones or blockers. For example, a business process that involves the sale of goods may include a requirement that a sales order (document) be created which identifies the goods and a requirement that an invoice (document) be generated and cleared. These three actions can be considered milestones. For example, the first milestone may be “creating a sales order”, a second milestone may be “creating an invoice”, and a third milestone may be “clearing the invoice”.

Meanwhile, blockers are occurrences or events that block the process from moving forward and will usually remain in place until the block is removed, if they don't directly terminate the process instance (e.g., the manual cancelation of an order). Referring again to the example of the three milestones above, the process may require that the buyer sign and return the sales order before the invoice can be generated by the system. In this example, failure to receive a signed sales order may be considered a blocker to the process. Until the signed sales order is received, the block will remain in place. Other contextual information reflecting such as unwanted or unintentional behavior (e.g., wrong sequence of process steps) can also be covered in such a definition of a blocker to surface these issues to the people responsible of running the process.

Such standardized milestones and blockers have been and can be identified from years of expertise in the field of process insights and avoid unnecessary mining projects which attempt to mine the entire state space of the process including parts of the process that are unrelated to the ultimate success of the process. While process mining can give you the whole state space including all irrelevant variants, paths and events, the example embodiments focus on identifying the standard blockers typically encountered by most businesses and the paths chosen to remedy these blockers. From a commercial perspective, the customer does not have to decide on one process to understand in depth but can get insights into challenges and blockers in a standardized way across the whole process landscape. The software system may provide pages of user interfaces which enable users to choose or otherwise select a subset of milestones from the predefined/standardized list and a subset of blockers for each milestone from another predefined/standardized list.

The data for identifying the insights can be extracted from process data stored in an underlying data store/database, for example, sales data, sales orders, invoices, payment transactions, account summaries, and the like, which can be used to see how the process is performing. To do this, the host system may query the process data and generate insights according using the systems and methods described in U.S. patent application Ser. No. 18/118,857, filed on Mar. 13, 2023, in the United States Patent and Trademark Office, the entire disclosure of which is fully incorporated herein by reference for all purposes.

In some embodiments, the process insights may be stored in a table or other data structure that can be analyzed by the host system to identify a list of events that occur during the process. Details of the events may be recorded in an event log such as a table or other structure. Furthermore, the host system can insert “virtual” events into the event log which are not found in the raw data but can be inferred from the other events that are found in the event log. The event log may include enough detail to build a process diagram (e.g., a graph) using existing process mining algorithms. The resulting process diagram may include a plurality of nodes that represent the plurality of milestones of the process, and/or other events that occur within the process. The nodes may include edges in-between which illustrate the “flow” of the process between the milestones and/or events. The flow may include directional edges, and annotations on the directional edges which include runtime attributes of the process such as completion percentage between two steps, average execution times, distribution between different succeeding edges and the like.

The host system may analyze the process diagram to provide the customer with intelligence associated with their process. For example, the host system may identify performance attributes of the process over time including what percentage of users reach each milestone, what percentage of users follow different paths within the process diagram, an order among the different steps in the process, and the like. The host system may also compare the performance attributes of the process to performance attributes of other processes that are of similar type. For example, the host system may compare a process diagram of a customer's process to a reference diagram (e.g., a process model) that is generated based on other process implementations of other customers that are of similar type. Here, the host system may overlay the reference diagram on top of the diagram of the target process to visualize the different flows between the two processes. For instance, customers can learn that in their make-to-stock process, process steps which they enforce in sequence are executed in arbitrary order by their industry peers, resulting in a process that, on average, executes 20% quicker. Furthermore, the host system may analyze the flows to identify which steps can be used to improve the target process and recommend suggestions on how to improve the target process based on alternative process steps identified from the reference diagram.

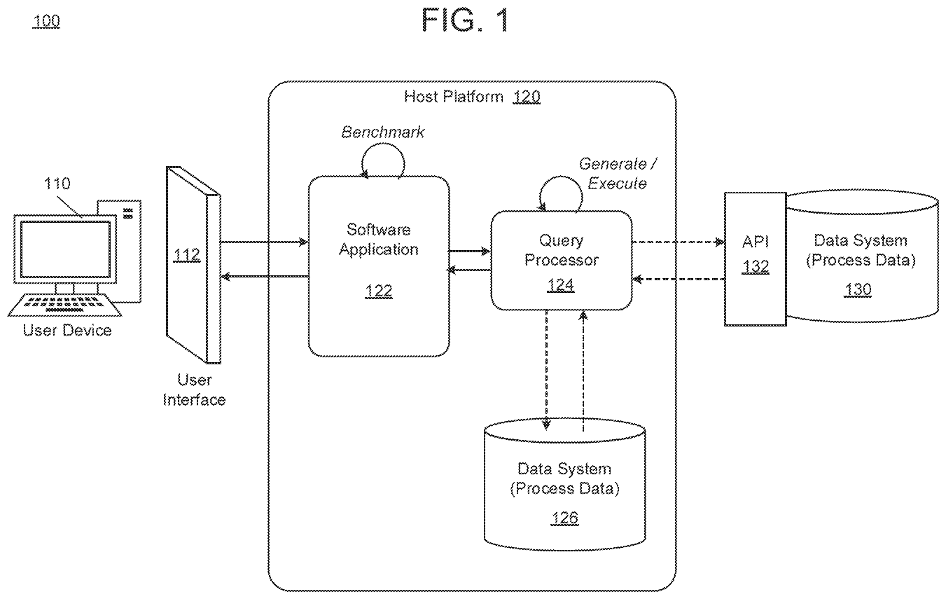

FIG. 1 illustrates a computing environment 100 of a host platform 120 for benchmarking a target process in accordance with an example embodiment. Referring to FIG. 1, the host platform 120 may be a cloud platform, a web server, a database, a combination of devices, and the like. The host platform 120 hosts a software application 122 for benchmarking. The software application may include one or more analytic programs that can analyze a business process and generate a benchmark of the process based on a reference process that contains the best practices of the process type. The data used by the software application 122 to benchmark the process may be stored in a data system, for example, data system 126 that is local to the host platform and/or data system 130 that is external to the host platform 120 and that is accessible via a network such as the Internet. As described herein, a data system may refer to a database, a website, a data service, a blockchain, or the like. The data system 126 may be accessed via an API and/or it may be accessed via a query such as a SQL query, or the like.

In this example, a user such as a process expert may interact with the software application 122 via a user device 110 such as a laptop computer, a mobile device, a desktop computer, a server, and the like. For example, the user may use the user device 110 to connect to a website, uniform resource locator (URL), or other location where the software application 122 is hosted. In some examples, the software application 122 is a progressive web application, a mobile application, or the like. In some embodiments, the software application 122 is actually a suite of multiple applications. The software application 122 may include a front-end with a user interface 112 that is output on a screen/display of the user device 110 once a session is established between the user device 110 and the host platform 120.

According to various embodiments, the user may select a system where the process data is located from among the data system 126 and the data system 130. In this example, the data system 130 is accessed via an application programming interface (API) such as API 132. The software application 122 may output guidance for the user via the user interface 112 to assist the user in selecting the correct system. A schema of the selected system may be uploaded to the software application 122 via the user interface 112. For example, the user may upload a file, a document, a spreadsheet, or the like which includes the schema information.

The software application 122 may also provide various user interfaces which enable the user to define milestones within the process and blockers for those milestones. The user interfaces may be accessible via a same page of the software application 122 or across multiple different pages of the software application 122. The user may also define a script or other instructions with query commands for querying the data necessary for analyzing the milestones and blocker(s) of the milestone via the user interface. Each blocker may have its own query, for example, a structured query language (SQL) query, or the like. The software application 122 may provide user interfaces and standardized lists of milestones and blockers (e.g., via drop-down menus, etc.) that the user can select from. Furthermore, software application 122 may also provide support and assistance in developing queries for accessing the data from the underlying data system.

When all queries for all blockers have been generated, the software application 122 may create a single script, API call, etc., which can be executed by a query processor 124 on the selected data system to retrieve the data necessary for analyzing each of the blockers via a single command. For example, the software application 122 may generate a structured query language (SQL) query for each of the blockers and then create a single script which extracts a union of all of the fields necessary from the data system. In some embodiments, the data system may also include an API, such as data system 130 which includes an API 132. In this example, the query generated by the software application 122 may include query commands and/or API calls for extracting or pushing the process data from the data system 130.

The generated script, query, etc. may be stored by the software application 122 and accessed by the user via the user device 110 or any other user with access to the process data via the software application 122. Here, the user may provide an identifier of the process (e.g., a process ID, etc.). In response, the software application 122 may query the selected data system based on the previously generated query corresponding to the process ID, and execute one or several analytic queries on the process data to generate insights about the process which can be displayed on the user interface 112. The process insights may include identifiers of milestones (e.g., events, activities, etc.) within the process and any blockers associated with the milestones. In addition, the insights may include context associated with the milestones and blockers such as how many users/customers are affected by the blockers, how many customers/users fail to finish the process, where customers are getting stuck in the process, and the like.

The process data that is pulled/extracted from the data systems 126 and 130 may include values of table data that are queried from tables stored in therein including order data, invoice data, payment data, shipping data, transportation data, inventory data, and the like. Through this data, the software application 122 can analyze the process data to identify insights associated with the process. For example, the software application 122 may identify how long it takes for each milestone to be reached (e.g., the amount of time that elapses between milestones) and the blockers that block these milestones from being achieved. To identify the duration between milestones, the software application 122 may use timestamps of when the process enters the two respective milestones on average and subtract the two.

In addition to identifications of the milestones and blockers of the process, the insights may also include an amount of elapsed time on average between the milestones such as an average amount of execution time between two process events, the number of processes that make it to each milestone (e.g., a percentage, ratio, etc.), the total cost of each process event, how each blocker affects the achievement of milestones within the process, and the like.

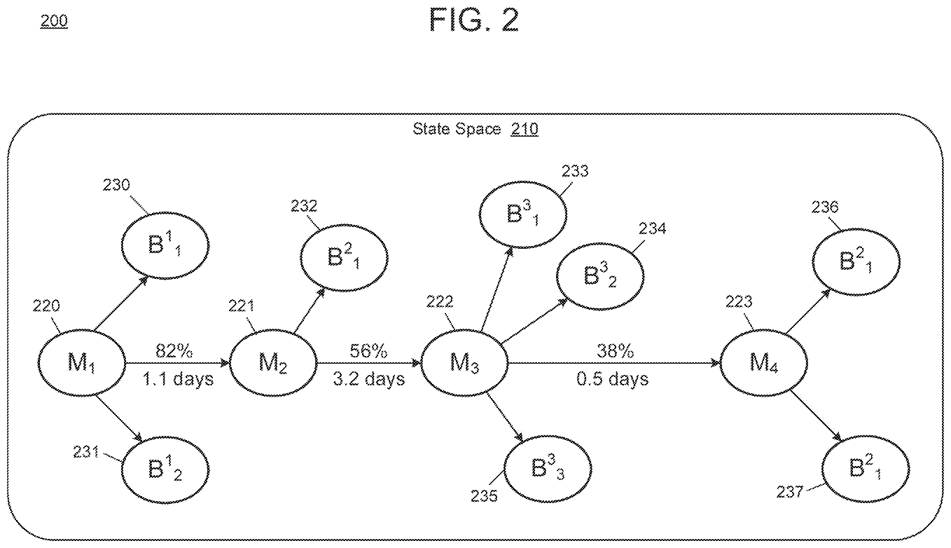

FIG. 2 illustrates a view 200 of a state space 210 of a process including milestones and blockers within the process in accordance with example embodiments. Referring to FIG. 2, the entire process space of a business process is shown as state space 210. The example embodiments restrict the size of the state space 210 based on predefined events in the process including a plurality of milestones 220, 221, 222, and 223, and a plurality of blockers 230, 231, 232, 233, 234, 235, 236 and 237 for the plurality of milestones 220, 221, 222, and 223. In this example, a blocker 230 is a blocker for milestone 220 within the process. Each milestone may have its own respective blockers or it may not. For example, each milestone may include zero blockers, one blocker, more than one blocker, and/or the like. In this way, the process is only analyzed based on the key areas of the process associated with milestones (e.g., document creation, document submission, document clearing, etc.) instead of the entire state space which can take significantly more time.

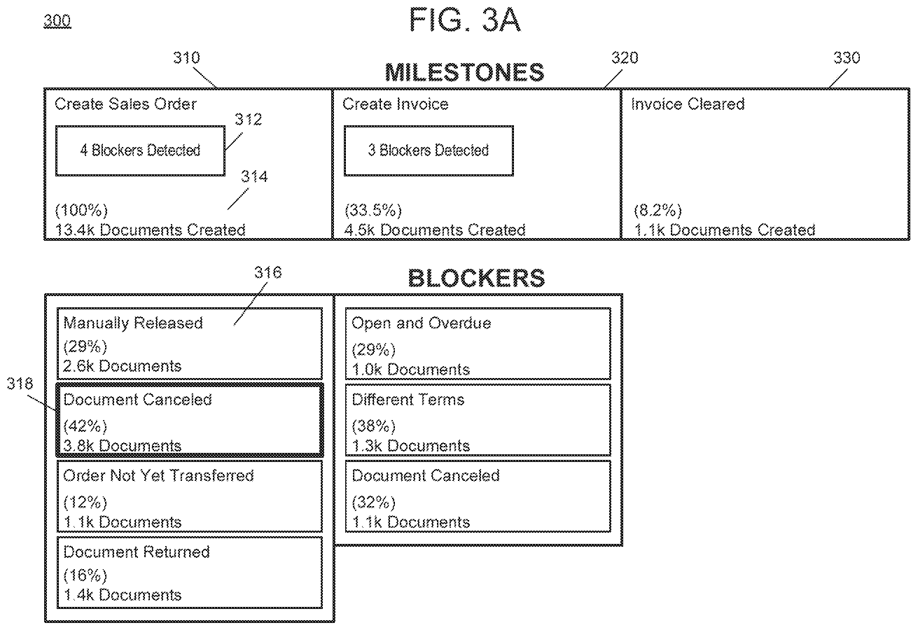

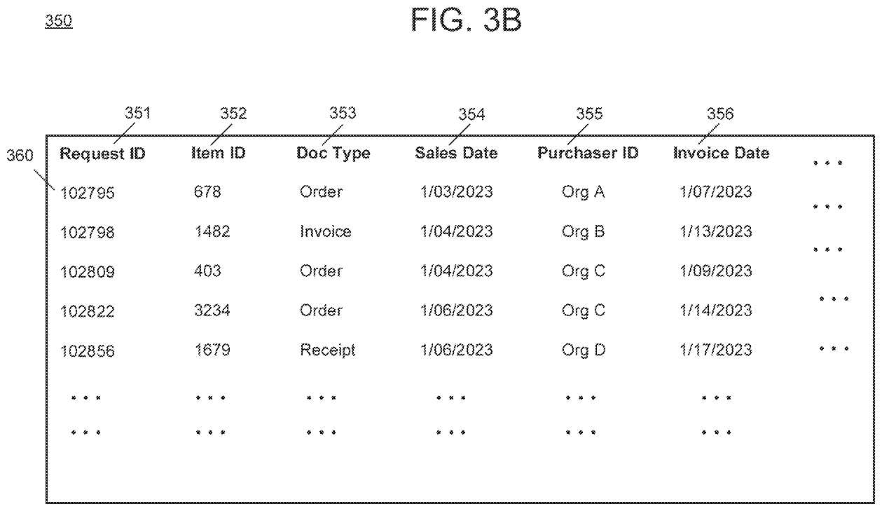

FIG. 3A illustrates a user interface 300 which includes identifiers of milestones and the blockers shown in FIG. 2, in accordance with example embodiments. Referring to FIG. 3A, the user interface 300 includes a display of insights including a plurality of milestones 310, 320, and 330, and attributes of the milestones including a number of blockers 312 that are detected and attributes 314 of the milestone with respect to other milestones. In this example, the milestones 310, 320, and 330 are executed in sequence within the end-to-end business process and each involves a document. In some cases, each milestone may correspond to documents involved in the process.

In this example, milestone 310 represents a step of generating a sales order, milestone 320 represents a step of generating an invoice based on the sales order, and milestone 330 represents clearing the invoice (based on successful payment). The milestone 310 includes four blockers which are shown below the milestone 310 including a blocker 316 directed to manually released documents. Other blockers including cancellation of documents, not transferring an order to the invoicing department, returning the sales order for errors, and the like. To assist the user in understanding the issues, the host system can display an identifier of the number of blockers 312 within the milestone 310, and also attributes 314 of the milestone 310 inside a content area of the graphical user interface (GUI) object of the milestone 310 on the user interface 300.

In addition to identifying the amount of time and the attributes of the milestones and the blockers, the host system (e.g., software application 122, etc.) may distinguish different graphical objects on the screen. As an example, the host system may highlight an object with a bold line 318 to identify this blocker as something that needs to be addressed more urgently as it is causing a lot of loss within the process. Thus, the system can identify a priority among the different blockers and display visual indicators of such priority or arrange the display of the blockers in an order based on the priority, etc. This priority is based on thresholds the process experts provided based on their experience for what is considered good or bad for the process execution when they defined the blockers.

In some embodiments, each milestone may be associated with a document that is involved in the process such as an order, an invoice, a financial document, or the like. The blockers may refer to actions or other events/items within the process that block or otherwise prevent the milestone (e.g., the document) from being completed in some way such as incorrect content, not yet submitted, submitted and returned, canceled, etc. Furthermore, each of the milestones 310, 320, and 330, may be visualized along with a number of documents generated for each milestone and the percentage or ratio of such documents that compete the milestone. For example, in FIG. 3A, the milestone 310 includes 13,400 documents (sales orders) being created, but only 4500 of the documents were eventually converted into invoices in the milestone 320. This corresponds to a loss ratio of about 66.6%. These insights can be provided to the user via the user interface 300.

FIG. 3B illustrates a data set 350 resulting from generating the process insights in FIG. 1, in accordance with example embodiments. The data set 350 may include a record of a particular item/product that is purchased via the process. Here, the data set 350 includes a plurality of columns 351, 352, 353, 354, 355, 356, etc., as well as columns not shown which can be analyzed by the host system to generate a log of events that have occurred within the process. In other words, the host system can analyze the data stored in the data set 350 which may include document data from the underlying database/data system, and generate a listing of events that have occurred within a process.

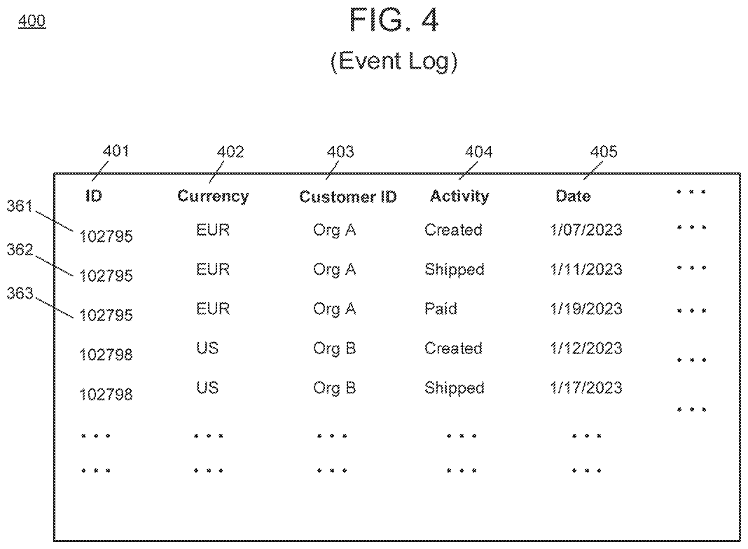

FIG. 4 illustrates an example of an event log 400 that can be generated from the data set 350 shown in FIG. 3B. Referring to FIG. 4, the event log 400 includes a plurality of columns of data values including columns 401, 402, 403, 404, 405, and the like. In this example, the event log 400 includes multiple events (e.g., three events, four events, etc.) which have been interpreted from each record shown in FIG. 3B. For example, a first record 360 shown in FIG. 3B includes three events 361, 362, and 363 in the event log 400 in FIG. 4. The events 361, 362, and 363 may be identified from within the same record using timestamps of the events which are stored in the record. For example, each timestamp may be paired with an action (e.g., invoice creation, etc.). The host system may analyze the records in the data set 350 and interpret the records to generate events which are added to the event log 400.

The events may include actions that occur within the process including creating a sales order, shipping the item to the customer, receiving payment for the item from the customer, etc. In many cases, the events may correspond to the milestones and/or the blockers already identified. The host system may identify the events within the event log 400 and pair the events with a corresponding timestamp from the record to generate a log entry in the event log 400. In other words, the host system may pair activities identified from the insight data with timestamps found in the insight data to generate an activity definition that can be analyzed for additional process insights. The process may be performed by an executable script creating one event log per standardized milestones definition of the process. Accordingly, the definition of this script generation the event log 400 is a one-time effort. The time it takes the script to complete execution (i.e., create the log) is based on the amount of data to process. Furthermore, state-of-the-art process mining solutions can display first process graphs (i.e., diagrams) within minutes.

For example, the event log 400 can be used to build a process graph of the process. For example, the process graph may be similar in appearance as a process diagram created from process mining. However, in this case, historical data (e.g., document data, etc.) is used to mine the process without interacting with the process.

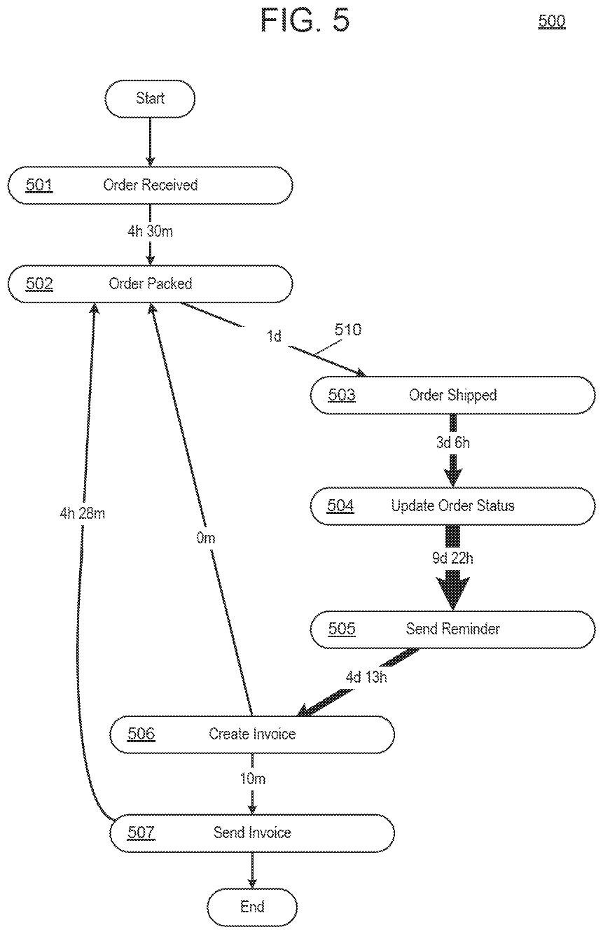

FIG. 5 illustrates an example of a process diagram 500 that may be generated based on document data such as the event log shown in FIG. 4, in accordance with example embodiments. The process diagram may include a plurality of nodes including a node 501, 502, 503, 504, 505, 506, and 507, representing events that occur during the process and edges 510 between the nodes identifying relationships between the events. For example, the edges 510 within the process diagram may be annotated with contextual attributes 512 of the process with respect to the two events connected by the edge such as average execution time between two the events, percentage of users that travel this part of the process, and the like. In some cases, the edges may be of different widths, colors, etc. to identify parts of the process that take longer than others. For example, the width of an edge may be directly correlated to the length of time between the two events of the two nodes connected by the edge.

For example, the host platform described herein (e.g., the software application 122 shown in FIG. 1) may convert document data, such as the document data that has been converted into the event log 400 shown in FIG. 4, into the process diagram 500 that is shown in FIG. 5. For example, the process includes a plurality of steps including a payment being process in a first step (the node 501), an order being packaged in a second step (node 502), the packaged order being shipped in a third step (the node 503), the order status of the package being updated in the system in a fourth step (the node 504), a reminder being sent on the order to an account in a fifth step (the node 505), creation of an invoice in a sixth step (the node 506), and sending of the invoice to the customer in a seventh step (the node 507). Furthermore, many of the nodes include reverse flows (directional edges going the other way) to previous nodes representing users that had to return to previous steps in the process due to issues and other errors.

Additionally, virtual events can be constructed wherever necessary. For example, a process mining algorithm may identify that after an event such as an invoice being created, the process does not provide any additional activity. In this example, the algorithm may infer a missing event (e.g., sending the invoice to the customer, etc.) based on comparisons of the process to implementations of other customers. In this case, a virtual event can be constructed and added to the process diagram, indicated as “missing”.

The process diagram may be stored within a repository. In some embodiments, a process diagram may be in the format of a Business Process Model and Notation (BPMN) model which is a standard for business process modeling. For example, the BPMN model can provide a graphical notation for specifying business processes in a Business Process Diagram (BPD) based on a flowcharting technique very similar to activity diagrams from Unified Modeling Language (UML). The objective of BPMN is to support business process management, for both technical users and business users, by providing a notation that is intuitive to business users, yet able to represent complex process semantics. The BPMN specification also provides a mapping between the graphics of the notation and the underlying constructs of execution languages, particularly Business Process Execution Language (BPEL).

BPMN models are expressed by simple diagrams constructed from a limited set of graphical elements. For both business users and developers, they simplify understanding of business activities' flow and process. BPMN's four basic element categories are Flow objects (e.g., events, activities, gateways, etc.), connecting objects (e.g., sequence flow, message flow, association, etc.), swim lanes (e.g., pool, lane, dark pool, etc.), and artifacts (e.g., data object, group annotation, etc.). These four categories enable creation of simple business process diagrams (BPDs). BPDs also permit making new types of flow object or artifact, to make the diagram more understandable.

Furthermore, the process diagrams described herein may be processed based on thresholds which are used to ensure the most relevant process variants are exported. For example, a process may include the following events (event A=created, event B=shipped, and event C=paid) which are observed in all permutations. Here simply constructing a graph diagram of such a process would result in a rather trivial graph/diagram which would not lead to insights about how the process is run. However, if the event sequence A, B, C makes up only 5% of the process runs while the event sequence A, C, B makes up 95% of all paths, a diagram showing these two variants is relevant and specific for the process and its owner/developer. His generation ensures traceability via identifiers (e.g., event type references for activities in process models, etc.) This also allows the host system to be used to automatically add live insights (e.g., KPI values) from process insights or other data sources to the corresponding activities in the process models.

When the process diagram has been created, the host system may select a reference diagram of the process and analyze it for additional insights. The reference diagram may be generated in advance and may include a sequence of steps that are best-practices in the industry for that type of process. The reference diagrams can be generated by users, generated by analysis, or the like. Here, the host system may compare the process diagram to the reference diagram to provide additional insight about how to improve the target process shown in the process diagram.

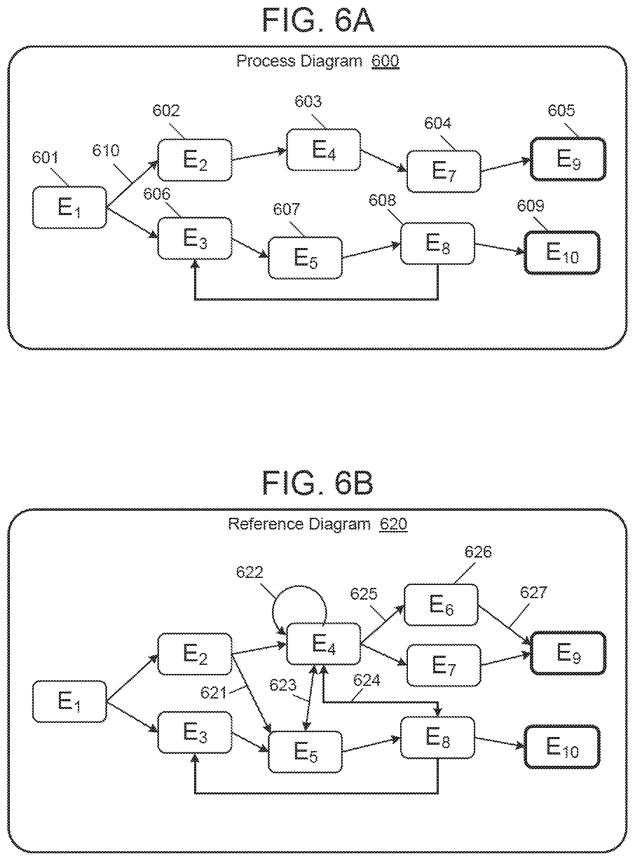

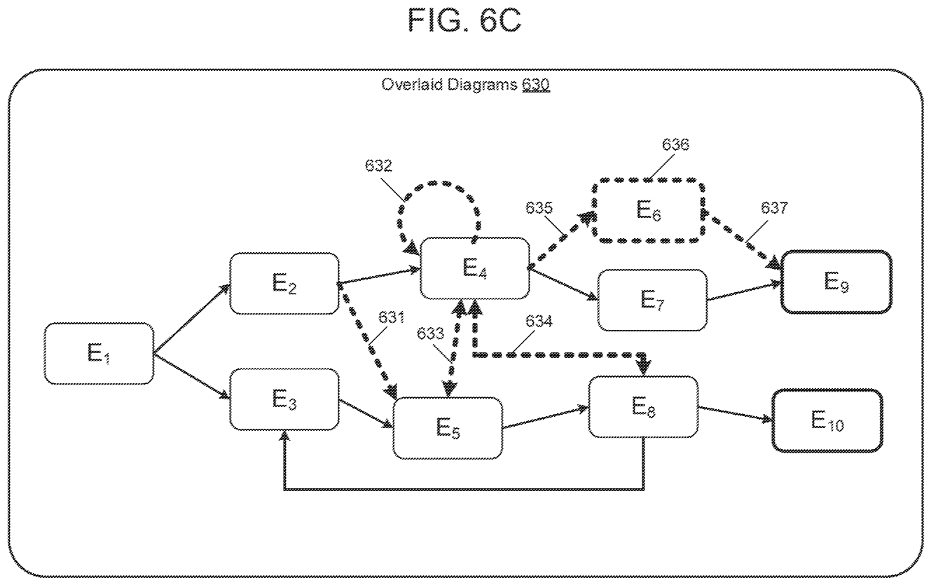

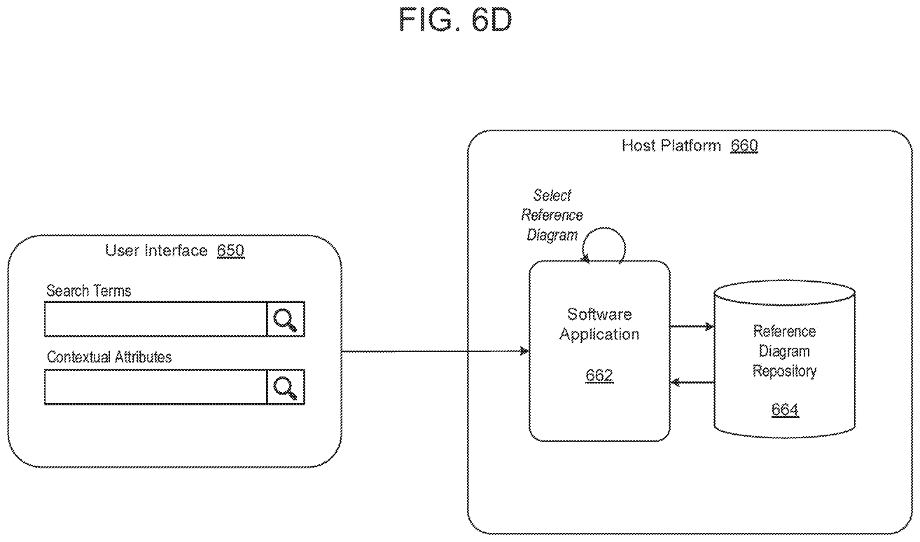

FIGS. 6A-6D illustrate a process of identifying a suggested improvement to a target process based on a reference diagram of a reference process in accordance with example embodiments. For example, FIG. 6A illustrates a process diagram 600 of a target process. The process diagram 600 may be generated from document data by the software application 122 described in the example of FIG. 1. The process diagram 600 includes a plurality of nodes 601-609 corresponding to a sequence of events that occur during execution of the target process and edges 610 between the plurality of nodes 601-609 which identify executional dependencies between the events. The process diagram 600 represents a current implementation of an organization's process. Further, a target process (more optimal process) can be derived based off of the benchmarking process described herein.

FIG. 6B illustrates a reference diagram 620 (also referred to herein as a reference process) that is related to the target process shown in the process diagram 600. For example, the reference process may be the same type of process, but with a different sequences of steps, edges, nodes, etc. than the target process. In this example, the reference diagram 620 includes the nodes 601-609 from the target process. In addition, the reference diagram also includes nodes 621-627, and edges therebetween that are from the reference process and which are not included in the target process. Based on process analyses using the same approach, the host platform 120 contains information about how other customers implemented their processes (126) and, e.g., that edge 621 is used by 90% of the industry peers which execute the process 20% faster. The reference diagram 620 may be a copy of another process (such as of another organization) that has been identified as being a best-in-class process. As another example, the reference diagram 620 may be generated by combining steps of the process from multiple different process diagrams in the same field to build a complete model of the process.

The reference diagram 620 may be supplied by the user (organization) that also submits the process diagram 600. As another example, the reference diagram 620 may be identified by the host platform, such as by searching for the reference diagram 620 using a search interface as described in FIG. 6D. It should be appreciated that there is not limitation to how the reference diagram 620 is generated.

According to various embodiments, the system described herein may overlay the reference diagram 620 on top of the process diagram 600 to generate a visualization of steps that can be integrated into the process diagram 600 to help improve the execution of the target process corresponding to the process diagram 600. Furthermore, the system may remove steps to prevent the process from becoming more complicated and thereby simplifying the process. For example, FIG. 6C illustrates a process 640 of overlaying the reference diagram 620 on the process diagram 600 to generate a pair of overlaid diagrams 630 within a user interface of the software application. In this example, the overlaid diagrams 630 illustrate suggested recommendations that include an alternative data flow 631, 632, 633, 634, 635, 636, and 637 within the target process by integrating the alternative data flow into the process diagram 600.

The overlaying process may integrate pieces of the reference diagram 620 into the process diagram 600. For example, the system may connect an edge 635 between an existing node (E4) of the process diagram 600 and a new node (E6) in the reference diagram 620 as shown in FIG. 6C to visually show how the existing process can be modified to create the improvement.

Here, the software may distinguish the recommended changes (different data flow/steps) on the user interface from the existing flow of the target process using highlighting, bold lines, thicker lines, different colors, shading, and the like. As a result, a viewer can quickly see what changes to make to the target process based on the alternative data flow including the node 636 and the edges 631, 632, 633, 634, 636, and 637 therein.

FIG. 6D illustrates a user interface 650 for searching for a reference diagram in accordance with an example embodiment. For example, a host platform 660 may host a software application 662 which carries out the benchmarking process described in the example embodiments. The software application 662 may include or otherwise have access to a repository 664 of reference diagrams. A user may enter keywords into a search bar on the user interface 650 which can be submitted to the software application 662.

Based on process performance metrics collected and derived for each different version of the process diagram customers might have implemented, customers can query the system to display the flow(s) associated with the best results when it comes to, e.g., completion rate, overall execution time or least manual effort. Since each customer might have optimized for different performance metrics, the customer can inspect which ones are most promising and easiest to adapt when overhauling their own processes. This, of course, needs to ensure anonymity of customers, e.g., by never displaying individual models but only aggregates of the top N customers for a metric.

According to various embodiments, the software application 662 may manage an index of information about the reference diagrams that are stored in the repository 664. For example, each diagram may have a description associated therewith that describes the type of process and the steps therein. The software application 662 may compare the search terms to these descriptions to identify a reference diagram with a description that most closely matches the search input. As another example, other attributes such as process type, location, etc. may be provided for the search and used to identify the reference diagram.

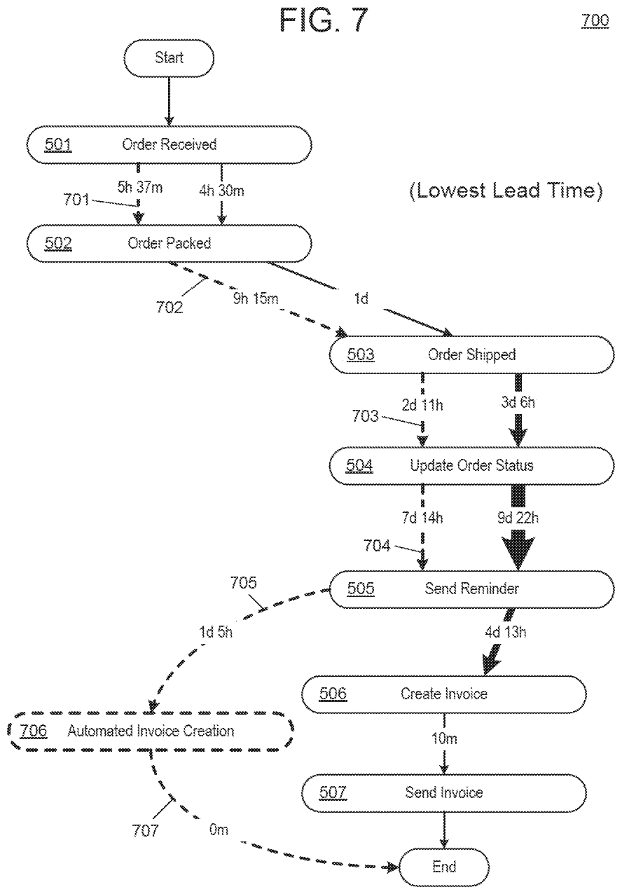

FIG. 7 illustrates a modified process diagram 700 that includes modifications to the process diagram of the target process shown in FIG. 5. In particular, the modified process diagram 700 includes an alternative flow path from that runs from the node 505 to the node 507 via a new node 706 that corresponds to a new event that is included in the reference process but not the target process. The new event can be integrated into the process diagram of the target process thereby visually illustrating the changes that need to be made to the process to improve the process execution.

According to various embodiments, the system described herein may overlay a reference diagram (of a reference process) on the process diagram 500 shown in FIG. 5, to generate the modified process diagram 700. Furthermore, the system may identify an improvement by analyzing the execution times within the reference diagram and the process diagram of the target process. For example, differences between execution times can be identified and used to identify changes in the target process that can be integrated from the reference process/reference diagram. As another example, cost analysis may be performed on the process and context associated therewith may be added to the annotated edges and used to determine the improvements to the target process.

In the example of FIG. 7, the best-in-class flow from the reference diagram is shown with a dotted line and includes edges 701, 702, 703, 704, 705, and 707, and it also includes the new node 706. Here, the best-in-class execution flow is shown in parallel to the execution flow of the target process that is determined from the process mining/document data. The system may visually differentiate the best-in-class flow from the flow of the target process within the modified process diagram 700 using bold lines, highlighting, different colors, and the like. Furthermore, timing data may be annotated on the edges to show how the process execution differs in time. Thus, a viewer can quickly understand which steps in the target process are causing a problem, and how to address the problem.

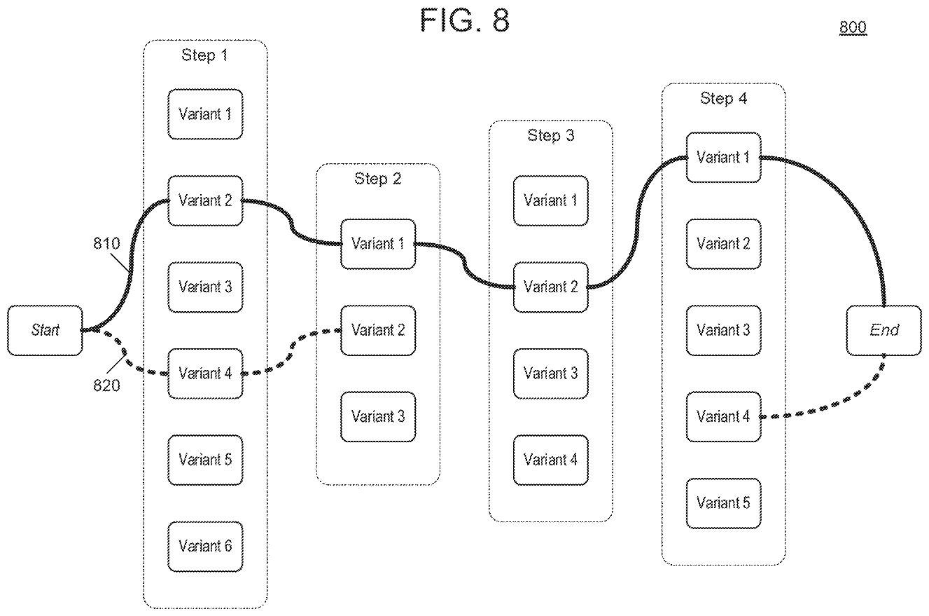

FIG. 8 illustrates a user interface 800 that includes an analysis of variants among a target process and a reference process in accordance with example embodiments. Referring to FIG. 8, here, the target process includes four steps with four different sets of variants. In particular, a first step includes six possible variants, a second step includes three possible variants, a third step includes four possible variants, and a fourth step includes five possible variants. In this example, the most common variant of the target process is shown with a path 810. Meanwhile, the most common variant for the best-in-class process is shown with a path 820. Here, the system identifies which variant most commonly occurs in the target process, and how that variant ranks in the reference process. Furthermore, the system may identify the most common variant in the best-as-is process and compare it to see where it ranks in the target process. The system may display the rankings on the user interface 800.

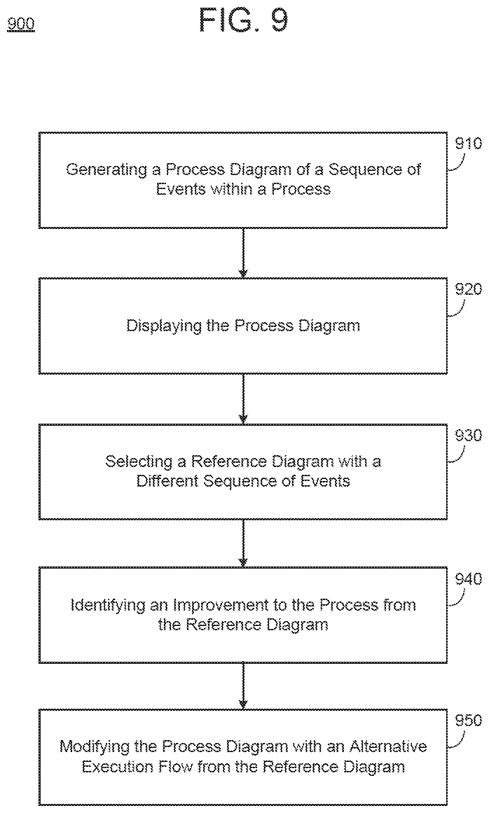

FIG. 9 illustrates a method 900 of generating a process graph based on process insights in accordance with example embodiments. For example, the method 900 may be performed by a software application hosted by a host platform such as a cloud platform, a web server, a distributed system, a database, or the like. Referring to FIG. 9, in 910, the method may include generating a diagram of a process based on data from the process. For example, the diagram may include a sequence of nodes that correspond to a sequence of events that occur within the process and edges between the sequence of nodes which indicate execution times between the sequence of events within the process.

In 920, the method may include displaying the process diagram via a user interface of a software application. Here, the diagram may be rendered within a window, slot, or other area with a template of the software application. In 930, the method may include selecting a reference diagram of a reference process from a data store, where the reference diagram has a different sequence of nodes corresponding to a different sequence of events than the sequence of events in the diagram. In 940, the method may include identifying an improvement to the process based on the reference diagram. In 950, the method may include modifying the diagram to include a different execution flow included in the reference diagram based on the identified improvement. For example, the method may include overlaying the reference diagram on top of/over the process diagram. In doing so, the differences between the process and the reference process can be visualized.

In some embodiments, generating the diagram may include annotating an edge between two nodes within the diagram corresponding to two different events within the process with an average execution time between the two different events. In some embodiments, the generating may include querying the data store for document data of the process, and identifying the sequence of events that occur within the process and the execution times between the sequence of events based on the document data. In some embodiments, the modifying may include inserting an alternative edge within the diagram between an existing node among the plurality of nodes within the diagram and a new node included in the different execution flow from the reference diagram.

In some embodiments, the selecting the reference diagram may include displaying a search bar via the user interface, receiving an input search term via the search bar displayed on the user interface, querying a plurality of descriptions of a plurality of respective reference diagrams in a storage device based on the search term, and selecting the reference diagram based on the queried plurality of descriptions in comparison to the input search term. In some embodiments, the modifying may include overlaying the reference diagram on top of the process diagram within the user interface, and identifying the improvement within the process diagram based on a comparison of an alternative process flow within the overlaid reference diagram to an existing process flow within the process diagram.

In some embodiments, the modifying may include visually distinguishing the alternative process flow within the overlaid reference diagram from an existing process flow of the process diagram when the reference diagram is overlaid on the process diagram. In some embodiments, the method may further include identifying a variant that occurs in each of the process and the reference process and identifying differences between the occurrences of the variant in each of the process and the reference process, and displaying the differences via the user interface.

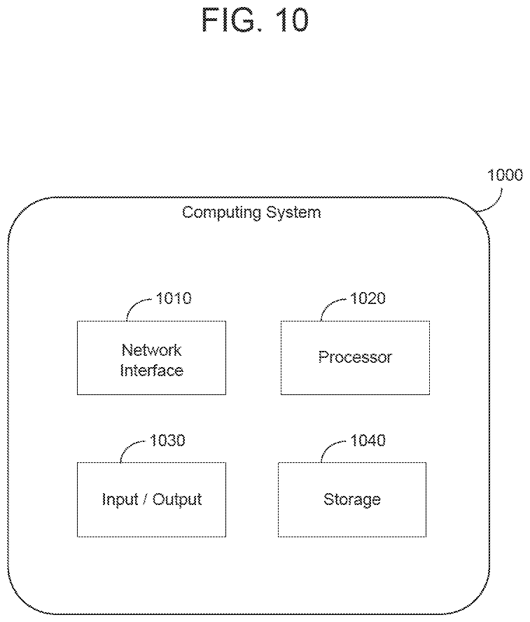

FIG. 10 illustrates a computing system 1000 that may be used in any of the methods and processes described herein, in accordance with an example embodiment. For example, the computing system 1000 may be a database node, a server, a cloud platform, or the like. In some embodiments, the computing system 1000 may be distributed across multiple computing devices such as multiple database nodes. Referring to FIG. 10, the computing system 1000 includes a network interface 1010, a processor 1020, an input/output 1030, and a storage 1040 such as an in-memory storage, and the like. Although not shown in FIG. 10, the computing system 1000 may also include or be electronically connected to other components such as a display, an input unit(s), a receiver, a transmitter, a persistent disk, and the like. The processor 1020 may control the other components of the computing system 1000.

The network interface 1010 may transmit and receive data over a network such as the Internet, a private network, a public network, an enterprise network, and the like. The network interface 1010 may be a wireless interface, a wired interface, or a combination thereof. The processor 1020 may include one or more processing devices each including one or more processing cores. In some examples, the processor 1020 is a multicore processor or a plurality of multicore processors. Also, the processor 1020 may be fixed or it may be reconfigurable. The input/output 1030 may include an interface, a port, a cable, a bus, a board, a wire, and the like, for inputting and outputting data to and from the computing system 1000. For example, data may be output to an embedded display of the computing system 1000, an externally connected display, a display connected to the cloud, another device, and the like. The network interface 1010, the input/output 1030, the storage 1040, or a combination thereof, may interact with applications executing on other devices.

The storage 1040 is not limited to a particular storage device and may include any known memory device such as RAM, ROM, hard disk, and the like, and may or may not be included within a database system, a cloud environment, a web server, or the like. The storage 1040 may store software modules or other instructions which can be executed by the processor 1020 to perform the methods described herein. According to various embodiments, the storage 1040 may include a data store having a plurality of tables, records, partitions and sub-partitions. The storage 1040 may be used to store database records, documents, entries, and the like.

According to various embodiments, the storage 1040 may include a data store such as a database that is configured to store document data of a process or multiple processes. Meanwhile, the processor 1020 may be configured to generate a process diagram that includes a sequence of nodes that correspond to a sequence of events that occur within a process and edges between the plurality of nodes which indicate execution times between the plurality events within the process. The processor 1020 may display the process diagram via a user interface of a software application. The processor 1020 may select a reference diagram of the process from a data store, where the reference diagram comprises a different sequence of nodes corresponding to a different sequence of events that occur within the reference process. The processor 1020 may identify an improvement to the process based on the reference diagram. The processor 1040 may modify the process diagram to include a different execution flow included in the reference diagram based on the identified improvement.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory medium.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a data store; and
a processor configured to
generate an image of a process which comprises a sequence of nodes displayed therein which correspond to a sequence of events that occur within the process and edges between the sequence of nodes which indicate execution times between the sequence of events within the process;
display the image via a user interface of a software application;
select a reference image of the process from a data store, where the reference image comprises a different sequence of nodes displayed therein corresponding to a different sequence of events that occur within the reference process;
identify an improvement to the sequence of events within the process based on a comparison of the image to the reference image; and
modify the image of the process to include a different execution flow included in the reference image based on the identified improvement.

2. The computing system of claim 1, wherein the processor is further configured to annotate an edge between two nodes within the image of the process corresponding to two different events within the process to include an average execution time between the two different events.

3. The computing system of claim 1, wherein the processor is further configured to retrieve process data from the data store, and identify the sequence of events that occur within the process and the execution times between the sequence of events based on the retrieved process data.

4. The computing system of claim 1, wherein the processor is configured to insert an alternative edge within the image of the process between an existing node among the sequence of nodes within the image of the process and a new node from the reference image of the process.

5. The computing system of claim 1, wherein the processor is further configured to display a search bar via the user interface, receive an input search term via the search bar displayed on the user interface, query metadata of a plurality of respective reference images in the data store based on the search term, and select the reference image based on the queried metadata in comparison to the input search term.

6. The computing system of claim 1, wherein the processor is configured to overlay the reference image on top of the image of the process within the user interface, and identify the improvement within the image of the process based on a comparison of an alternative process flow within the overlaid reference image to an existing process flow within the image of the process.

7. The computing system of claim 6, wherein the processor is configured to visually change one or more of a color and a width of the alternative process flow when the reference image is overlaid on the image of the process to distinguish the alternative process flow from an existing process flow of within the image of the process.

8. The computing system of claim 1, wherein the processor is further configured to identify a variant that occurs in each of the process and the reference process, identify differences between the occurrences of the variant in each of the process and the reference process, and display the differences via the user interface.

9. A method comprising:
generating a diagram of a process based on data from the process, where the diagram comprises a sequence of nodes that correspond to a sequence of events that occur within the process and edges between the sequence of nodes which indicate execution times between the sequence of events within the process;
displaying the diagram via a user interface of a software application;
selecting a reference diagram of a reference process from a data store, where the reference diagram comprises a different sequence of nodes corresponding to a different sequence of events than the sequence of events in the diagram;
identifying an improvement to the process based on the reference diagram; and
modifying the diagram to include a different execution flow included in the reference diagram based on the identified improvement.

10. The method of claim 9, wherein the generating the diagram comprises annotating an edge between two nodes within the diagram corresponding to two different events within the process with an average execution time between the two different events.

11. The method of claim 9, wherein the generating comprises querying the data store for document data of the process, and identifying the sequence of events that occur within the process and the execution times between the sequence of events based on the document data.

12. The method of claim 9, wherein the modifying comprises inserting an alternative edge within the diagram between an existing node among the sequence of nodes within the diagram and a new node included in the different execution flow from the reference diagram.

13. The method of claim 9, wherein the selecting the reference diagram comprises displaying a search bar via the user interface, receiving an input search term via the search bar displayed on the user interface, querying a plurality of descriptions of a plurality of respective reference diagrams in a storage device based on the search term, and selecting the reference diagram based on the queried plurality of descriptions in comparison to the input search term.

14. The method of claim 9, wherein the modifying comprises overlaying the reference diagram on top of the process diagram within the user interface, and identifying the improvement within the process diagram based on a comparison of an alternative process flow within the overlaid reference diagram to an existing process flow within the process diagram.

15. The method of claim 14, wherein the modifying comprises visually distinguishing the alternative process flow within the overlaid reference diagram from an existing process flow of the process diagram when the reference diagram is overlaid on the process diagram.

16. The method of claim 9, wherein the method further comprises identifying a variant that occurs in each of the process and the reference process and identifying differences between the occurrences of the variant in each of the process and the reference process, and displaying the differences via the user interface.

17. A computer-readable medium comprising instructions which when executed by a processor cause a computer to perform a method comprising:
generating a process diagram that comprises a sequence of nodes that correspond to a sequence of events that occur within a process and edges between the sequence of nodes which indicate execution times between the sequence of events within the process;
displaying the process diagram via a user interface of a software application;
selecting a reference diagram of a reference process from a data store, where the reference diagram comprises a different sequence of nodes corresponding to a different sequence of events than the sequence of events in the diagram;
identifying an improvement to the process based on the reference diagram; and
modifying the process diagram to include a different execution flow included in the reference diagram based on the identified improvement.

18. The computer-readable medium of claim 17, wherein the generating the process diagram comprises annotating an edge between two nodes within the process diagram corresponding to two different events within the process to include an average execution time between the two different events.

19. The computer-readable medium of claim 17, wherein the generating comprises querying the data store for document data of the process, and identifying the sequence of events that occur within the process and the execution times between the sequence of events based on the document data.

20. The computer-readable medium of claim 17, wherein the modifying comprises inserting an alternative edge within the process diagram between an existing node among the sequence of nodes within the process diagram and a new node included in the different execution flow from the reference diagram.
